(19) United States
(12) Patent Application Publication
(10) Pub. No.: US 2014/0020829 A1
(43) Pub. Date: Jan. 23, 2014

(54) Sensors in Carrier Head of a CMP System

(71) Applicants: Hung Chih Chen, Sunnyvale, CA (US); Gautam Shashank Dandavate, Sunnyvale, CA (US); Samuel Chu-Chiang Hsu, Palo Alto, CA (US); Denis M. Koosau, Pleasanton, CA (US)

(72) Inventors: Hung Chih Chen, Sunnyvale, CA (US); Gautam Shashank Dandavate, Sunnyvale, CA (US); Samuel Chu-Chiang Hsu, Palo Alto, CA (US); Denis M. Koosau, Pleasanton, CA (US)

(73) Assignee: APPLIED MATERIALS, INC., Santa Clara, CA (US)

(21) Appl. No.: 13/552,377

(22) Filed: Jul. 18, 2012

(51) Int. Cl. B05C 9/08

(52) U.S. Cl. 156/345.13

(57) ABSTRACT

Sensors can be located in a carrier head for a chemical mechanical polishing system. In some implementations the carrier head includes a flexible membrane, and a thermocouple is positioned on the lower surface of the flexible membrane or embedded in the flexible membrane adjacent the lower surface. In some implementations, the carrier head optical sensor is secured to the head and positioned to sense a reflectivity of a spot on a back surface of a substrate held in the carrier head, and a controller is configured to receive a signal from the optical sensor and determine precession of the substrate based on the signal.

### TECHNICAL FIELD

This disclosure relates to a carrier head for chemical mechanical polishing and sensing polishing parameters.

### BACKGROUND

Integrated circuits are typically formed on substrates, particularly silicon wafers, by the sequential deposition of conductive, semiconductive or insulative layers. After each layer is deposited, the layer is etched to create circuitry features. As a series of layers are sequentially deposited and etched, the outer or uppermost surface of the substrate, i.e., the exposed surface of the substrate, becomes increasingly non-planar.

Chemical mechanical polishing (CMP) is one accepted method of planarizing a substrate surface. This planarization method typically requires that the substrate be mounted to a carrier or polishing head. The exposed surface of the substrate is then placed against a rotating polishing pad. The temperature of the slurry and substrate can affect the polishing rate.

Some carrier heads include a flexible membrane with a mounting surface for the substrate. A chamber on the other side of the membrane can be pressurized to press the substrate against the polishing pad.

### SUMMARY

Although polishing systems have been proposed in which a temperature is measured with an infrared sensor, there can be difficulties in obtaining a reliable measurement of the temperature of the substrate. For example, the heat from the substrate being polished needs to pass through either the polishing pad or the membrane in the carrier head to reach the infrared sensor, which can interfere with the measurement. An approach which could address these issues is to embed a thermocouple in the membrane of the carrier head.

Another issue is that during polishing, due to slippage between the membrane and the substrate, the substrate does not necessarily rotate at the same rate as the carrier head. Precession refers to this relative rotation between the substrate and the carrier head. By placing an optical sensor within the carrier head, marking on the back side of the substrate can be monitored and the precession of the substrate can be measured.

In one aspect, a carrier head for a chemical mechanical polishing system includes a base and a flexible membrane connected to and extending beneath the base to define a pressurizable chamber therebetween. The flexible membrane has a lower surface to provide a substrate-mounting surface. A thermocouple is positioned on the lower surface of the flexible membrane or embedded in the flexible membrane adjacent the lower surface, and wiring provides access to a signal from the thermocouple.

Implementations may include one or more of the following features. A plurality of thermocouples may be positioned on the lower surface of the flexible membrane or embedded in the flexible membrane adjacent the lower surface. The plurality of thermocouples may be positioned at different radial distances from a center of the substrate-mounting surface. The plurality of thermocouples may be positioned along a radial line extending from the center of the substrate-mounting surface. Adjacent pairs of thermocouples may be separated by equal radial distances. A first thermocouple may be positioned at the center of the substrate mounting surface and a second thermocouple may be positioned adjacent an edge of the substrate mounting surface. The thermocouple may be positioned on the lower surface of the flexible membrane. The thermocouple may be embedded in the flexible membrane adjacent the lower surface. A signal processor may be secured to the carrier head, the wiring may connect the thermocouple to the signal processor, and the signal processor may be configured to generate digital temperature values from the signal from the thermocouple. A data storage device may be configured to store the digital temperature values.

In another aspect, a chemical mechanical polishing system includes a carrier head and a controller. The carrier head includes a substrate mounting surface and an optical sensor secured to the head and positioned to sense a reflectivity of a spot on a back surface of a substrate held in the carrier head. The controller is configured to receive a signal from the optical sensor and determine precession of the substrate based on the signal.

Implementations may include one or more of the following features. The optical sensor may include a light source configured to direct a light beam to the spot on the back surface and a detector configured to sense reflections of the light beam from the back surface. The carrier head may include a base and a flexible membrane connected to and extending beneath the base to define a pressurizable chamber therebetween, the flexible membrane having a lower surface to provide the substrate-mounting surface. The light source may be positioned to direct the light beam through the flexible membrane and receive reflections of the light beam through the flexible membrane. The optical sensor may be positioned in the chamber. The controller may be configured to calculate a rate of precession of the substrate or to calculate an angular position of the substrate. The optical sensor may generate an intensity signal and the controller is configured to detect a valley in the signal. The substrate may have a feature on the back surface with a different reflectivity than the remainder of the back surface. The feature may include a marking of a material applied to the back surface of the substrate, or a notch or flat of the substrate.

Potential advantages may include one or more of the following. The temperature of the substrate can be measured in-situ during polishing, and the measurement can be more accurate and reliable. If multiple thermocouples are embedded in the membrane, then temperatures can be measured at multiple positions on the substrate. The measured temperature(s) can be input into a control system and used to adjust a polishing parameter, e.g., to provide more uniform polishing. Precession of the substrate can be measured in-situ during polishing. The measured temperature can be input into a control system and used to adjust a polishing parameter. Angular asymmetry in the polishing rate across the substrate can be reduced.

The details of one or implementations are set forth in the accompanying drawings and the description below. Other features, objects, and advantages will be apparent from the description and drawings, and from the claims.

### DESCRIPTION OF DRAWINGS

FIG. 1 illustrates a schematic partially cross-sectional view of an example of a polishing apparatus.

FIG. 2 is a schematic bottom view of a carrier head.

FIG. 3 is a graph of temperature as a function of time based on data from an in-situ temperature monitoring system.

FIG. 4 is a schematic diagram of an optical sensor.

FIG. 5 is a schematic backside view of a substrate.

FIGS. 6A and 6B are schematic top views of a notched substrate and a flatted substrate, respectively.

FIG. 7 is a graph of light intensity as a function of time based on data from an in-situ substrate precession monitoring system.

Like reference symbols in the various drawings indicate like elements.

### DETAILED DESCRIPTION

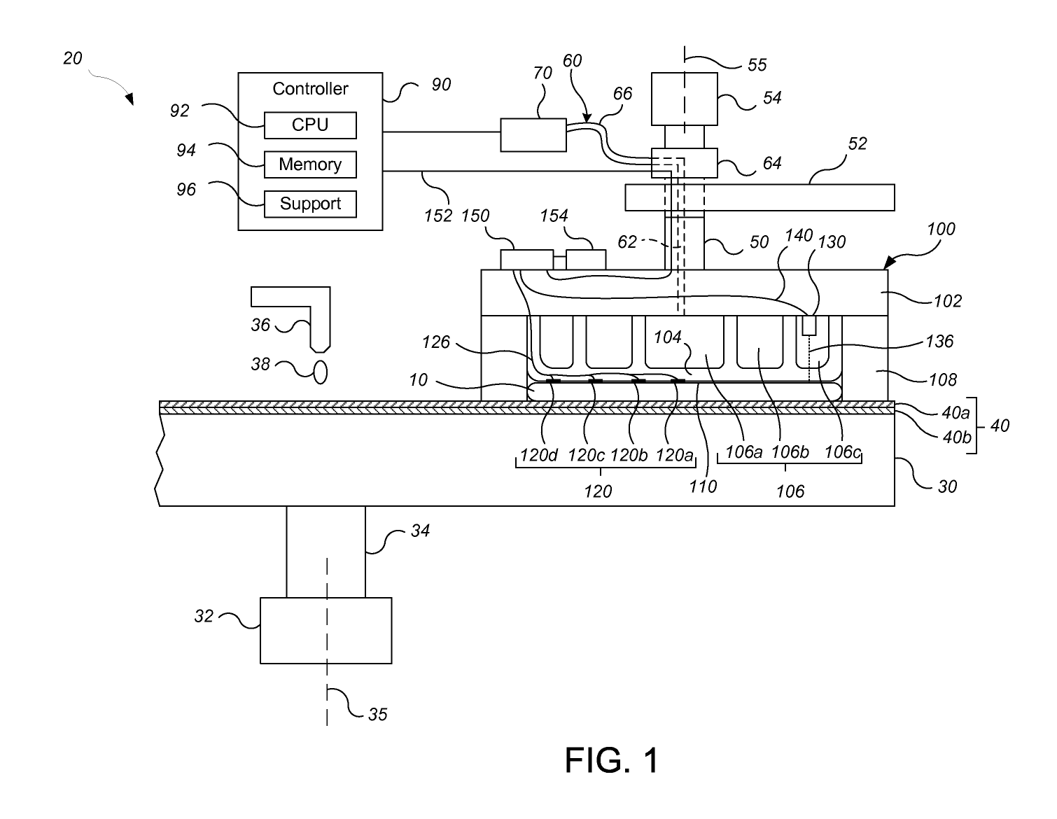

A carrier head 100 of a chemical mechanical polishing (CMP) apparatus 20 is illustrated schematically in FIG. 1. A description of a CMP apparatus may be found in U.S. Pat. No. 5,738,574, the entire disclosure of which is incorporated herein by reference. The CMP apparatus 20 can include a rotatable platen 30 that supports a polishing pad 40. For example, a motor 32 can turn a drive shaft 34 to rotate the platen 30 and the polishing pad 4 about an axis 35. The polishing pad 40 can be a two-layer polishing pad with an outer polishing layer 40a and a softer backing layer 40b.

A dispenser 36, such as a combined slurry/rinse arm, supplies a slurry 38 to the surface of the polishing pad 40. While only one slurry/rinse arm 36 is shown, additional nozzles, such as one or more dedicated slurry arms per carrier head, can be used. The polishing apparatus can also include a polishing pad conditioner to abrade the polishing pad 40 to maintain the polishing pad 40 in a consistent abrasive state.

The polishing apparatus 20 includes at least one carrier head 100. The carrier head 100 is operable to hold a substrate 10 against the polishing pad 40. The carrier head 100 includes a base 102 and a flexible membrane 104 connected to the base 102 which defines at least one pressurizable chamber 106 located between the base 102 and the flexible membrane 104. A lower surface 110 of the flexible membrane 104 provides a substrate mounting surface to receive the substrate 10. The carrier head 100 can include a retaining ring 108 to retain the substrate 10 below a flexible membrane 144.

In the implementation illustrated in FIG. 1, the carrier head 140 includes a plurality of independently controllable pressurizable chambers 106, e.g., three chambers 106a-106c, defined by the membrane 104. The chambers 106 can apply independently controllable pressures to associated zones on the flexible membrane 104 and thus on the substrate 10. A center chamber 106a, and thus a center zone can be substantially circular. The remaining chambers 106b, 106c can be concentric annular chambers around the center chamber 106a, and the remaining zones could be concentric annular chambers zones around the center zone. Although three chambers are illustrated in FIG. 1, there could be one chamber, two chambers, or four or more chambers, e.g., five chambers.

The base 102 can be directly secured to a drive shaft 50. Alternatively, the base 102 can be connected to a housing which is secured to the drive shaft, and a chamber between the base 102 and the housing can control the vertical position of the base. Other features of the carrier head may be found in U.S. Pat. No. 7,699,688, the entire disclosure of which is incorporated herein by reference.

The carrier head 100 is suspended from a support structure 52, e.g., a carousel, and is connected by the drive shaft 50 to a carrier head rotation motor 54 so that the carrier head can rotate about an axis 55. Optionally the carrier head 100 can oscillate laterally, e.g., on sliders on the carousel 52 or by rotational oscillation of the carousel itself. In operation, the platen is rotated about its central axis 35, and the carrier head is rotated about its central axis 55 and optionally translated laterally across the top surface of the polishing pad 40.

The chambers 106a-106c are fluidically connected by pressure supply lines 60 (only one pressure supply line, for chamber 106a, is illustrated in FIG. 1 for clarity) to a pneumatic control system 70, e.g., a system of pressure sensors and valves that can regulate pressure in the pressure supply lines 60 and thus the pressure in the chambers 106a-106c. Each pressure supply line 60 can include a passage 62 that extends through the drive shaft 50 and the base 102 to the chamber, and tubing 66, e.g., a pipe or hose, that fluidly connects the pneumatic control system 70. The passage 62 can be connected to the tubing 66 by a rotary coupler 64. However, many other arrangements are possible for the pressure supply lines 60.

The polishing apparatus also includes an in-situ monitoring system, which can be used to determine whether to adjust a polishing parameter. The in-situ monitoring system includes one or more sensors installed in the carrier head 100. The in-situ monitoring system can include either an in-situ substrate temperature monitoring system or an in-situ substrate precession monitoring system, or both. Signals from the in-situ monitoring system can be passed to controller 90.

The controller 90 can include a central processing unit (CPU) 92, a memory 94, and support circuits 96, e.g., input/output circuitry, power supplies, clock circuits, cache, and the like. The memory is connected to the CPU 92. The memory is a non-transitory computable readable medium, and can be one or more readily available memory such as random access memory (RAM), read only memory (ROM), floppy disk, hard disk, or other form of digital storage. In addition, although illustrated as a single computer, the controller 90 could be a distributed system, e.g., including multiple independently operating processors and memories.

In addition to receiving signals from the in-situ monitoring system (and any other endpoint detection systems), the controller 90 can be connected to the polishing apparatus 100 to control the polishing parameters, e.g., the various rotational rates of the platen(s) and carrier head(s) and pressure(s) applied by the carrier head, by connection to the respective motors or actuators. The controller 90 can also be configured to store or determine a desired pressure for the chambers 106a-106c in the carrier head 100. The controller 90 and pneumatic control system 70 can communicate, e.g., the controller 90 can be configured to send commands to the pneumatic control system 70 in response to which the pneumatic control system can apply the desired pressure to the pressure supply lines 60. The controller 90 can include a computer program product implemented in non-transient computer readable media to perform these and other operations. For example, if the carrier head includes multiple chambers, the controller 80 can also be configured to set the pressures in the multiple chambers to provide improved polishing uniformity.

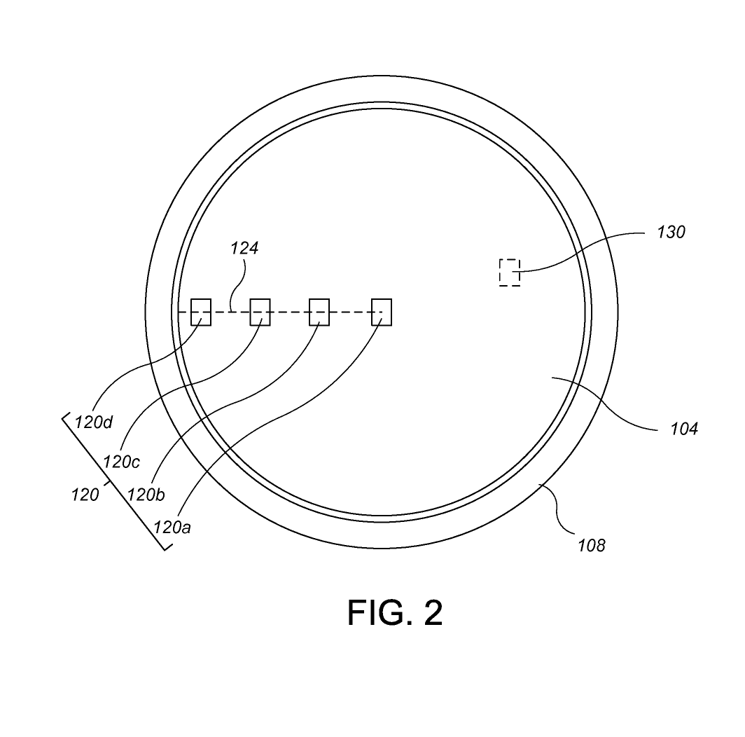

Referring to FIGS. 1-2, in some implementations the in-situ monitoring system can include an in-situ substrate temperature monitoring system. The in-situ temperature monitoring system includes one or more thermocouples 120 that serve as the temperature sensors. As shown in FIG. 1, the thermocouples 120 are attached to the bottom surface 110 of the membrane 104. This permits the thermocouples 120 to directly contact the substrate 10 when the substrate is held in the carrier head 100. Alternatively, the thermocouples 120 can be embedded in the membrane 104. Although FIGS. 1-2 illustrate four thermocouples 120a-120d, the carrier head could have one, two, three, or five or more thermocouples.

Where there are multiple thermocouples 120, the thermocouples 120 can be positioned at different radial distances from the center of the of the substrate mounting surface of the membrane 104. For example, as shown in FIG. 2, an innermost thermocouple 120a can be positioned at the center of the substrate mounting surface of the membrane 104, and an outermost thermocouple 120d can be positioned near an edge of the substrate mounting surface of the membrane 104. In some implementations, the thermocouples 120 are positioned on a radial line 124 of the substrate mounting surface. In some implementations, the thermocouples 120 are uniformly spaced apart.

The thermocouples 120 can be electrically coupled to a signal processor 150 by wires 126. The wires 126 can be embedded in the membrane 104, can run along the outer surface 110 of the membrane 104, or can extend through one or more of the chambers 106. The signal processor 150 can convert analog voltages from the thermocouples 120 into digital signals, e.g., digital temperature values.

Digital signals, e.g., the temperature values, from the signal processor 150 can be input to the controller 90 as discussed above. For example, the signal processor 150 can be connected to the controller by a wiring 152 that runs through the rotary coupler 64. Alternatively, the signal processor 150 could send the digital signals to the controller 90 through a wireless connection. Alternatively, the digital signals could be recorded on a data storage device 154, e.g., a hard disk or a flash memory card. The data logger 154 is physically attached to the carrier head 100, and the data can be retrieved after the polishing operation is completed.

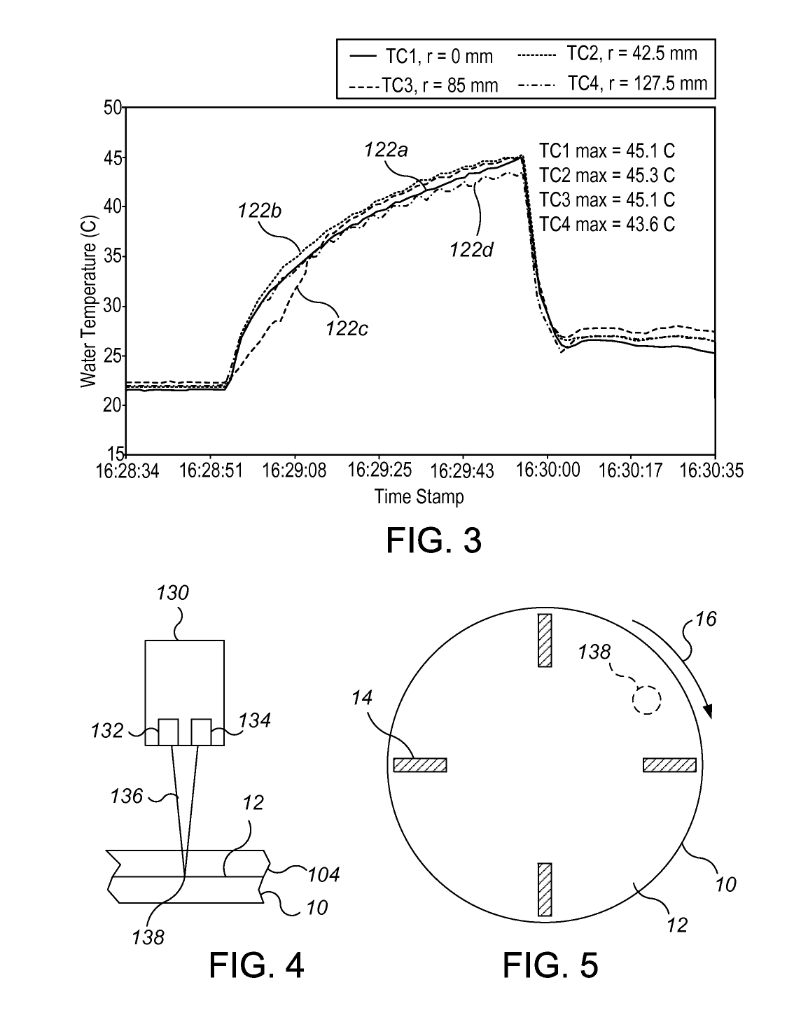

FIG. 3 shows an example of temperature measurements 122a-122d as a function of time for the thermocouples 120a-120d.

A benefit of using a thermocouple is that the thermocouple can be positioned on or in the membrane 104. This permits the temperature sensor to be positioned in direct contact with the substrate, so that neither the membrane nor the polishing pad interferes with the temperature measurement. This can make the temperature measurement more accurate.

A benefit of using multiple thermocouples is that the substrate temperature can be measured at multiple radial positions. Since the polishing rate is dependent on the substrate temperature, this permits a polishing parameter, e.g., a pressure in one of the multiple chambers 106, to be adjusted to provide more uniform polishing. For example, if the controller 90 determines that the temperature for one zone of the substrate is higher than others, the controller can reduce the polishing pressure applied by a corresponding chamber of the carrier head in order to reduce the polishing rate and compensate for the higher temperature. Conversely, if the controller 90 determines that the temperature for one zone of the substrate is lower than others, the controller can increase the polishing pressure applied by a corresponding chamber of the carrier head in order to increase the polishing rate and compensate for the lower temperature.

In some implementations the in-situ monitoring system can include an in-situ substrate precession monitoring system. Referring to FIG. 4, the in-situ substrate precession monitoring system includes an optical sensor 130. The optical sensor 130 can include a light source 132 and a detector 134. Referring to FIGS. 1 and 4, the light source 132 generates a light beam 136 that passes through the membrane 104 and illuminates a spot 138 on the back surface of the substrate 10. The light reflected from the back surface 12 of the substrate 10 can be sensed by the detector 134. In order to be reflected by the back surface 12 of the substrate, the light beam 136 should be in the visible light range. The flexible membrane 104 can be formed of a material that is transmissive to at least some wavelengths in the visible light range, e.g., silicone.

As shown by FIG. 1, the optical sensor 130 can be installed on the carrier head 100, e.g., secured to the base 102. In some implementations, the optical sensor 130 can be positioned in one of the chambers 106.

Referring to FIG. 5, the back surface 12 of the substrate 10 includes one or more features 14 with a different reflectivity than the remainder of the back surface 12. The features 14 can be lower reflectivity than the back surface 12. The features 14 are positioned at least over a radial range on the back surface 12 that corresponds to the illuminated spot 138 on the back surface 12. Thus, due to the precession (shown by arrow 16) of the substrate 10, the spot 138 intermittently passes over the features 14.

In some implementations, the features are markings provided by a material, e.g., a tape or ink, that is applied to the back surface 12 of the substrate 10. Alternatively or in addition, the features 14 can be part of the semiconductor wafer itself, e.g., etched regions on the back surface 12 of the substrate 10. The features 14 can be spaced at about equal angular intervals around the center of the substrate 10.

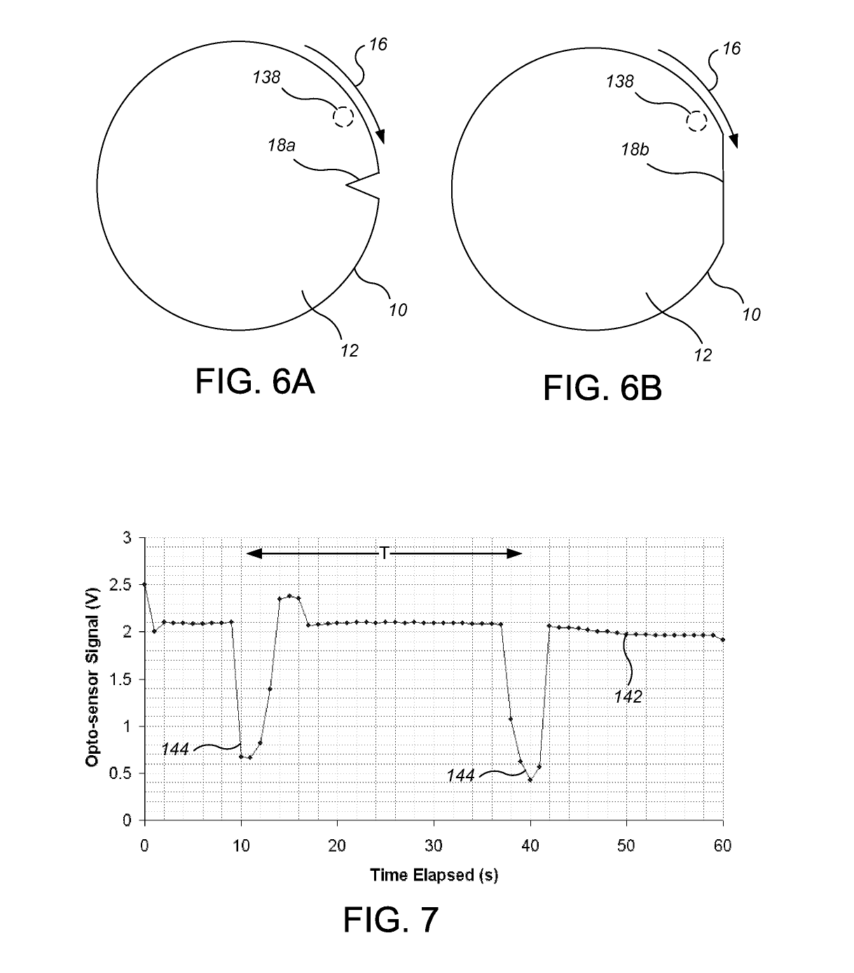

Alternatively or in addition, the features can be provided by the edge of the substrate 10. For example, the substrate 10 can include a notch 18a (see FIG. 6A) or a flat 18b (see FIG. 6B). Thus, due to the precession (shown by arrow 16) of the substrate 10, the spot 138 intermittently passes over the notch or flat, resulting in a change in reflectivity.

The optical sensor 130 can be electrically coupled to the signal processor 150 by wires 140. The signal processor 150 can convert analog voltages from the optical sensor 130 into digital signals, e.g., digital intensity values.

Digital signals, e.g., the intensity values, from the signal processor 150 can be input to the controller 90 as discussed above. For example, the signal processor 150 can be connected to the controller by a wiring 152 that runs through the rotary coupler 64. Alternatively, the signal processor 150 could send the digital signals to the controller 90 through a wireless connection. Alternatively, the digital signals could be recorded on a data logger 154, e.g., a hard disk or a flash memory card. The data logger 154 is physically attached to the carrier head 100, and the data can be retrieved after the polishing operation is completed.

FIG. 7 shows an example of intensity signal 142 as a function of time from the optical sensor 130. As noted above, due to the precession of the substrate 10, the spot 138 intermittently passes over the features 14. In this example, the features 14 have lower reflectivity than the back surface, so each time the spot passes over the feature there is a valley 144 in the signal 142. By sensing the reduction in the intensity signal 142, the controller 90 can determine each time that a feature 14 passes below the sensor 130.

Assuming that the substrate precesses in a single direction, the controller 90 can count the number of times that the feature 14 has passed below the sensor 130. Based on the number of times that the feature 14 has passed below the sensor, the controller 90 can calculate the angular position A of the substrate 10, e.g., A=N*B, where N is the number of times and B is the angular distance between adjacent features 14. In addition, the controller 90 can calculate a rate R of angular precession, e.g., R=B/T, where T is the time between adjacent valleys in the signal.

A benefit of determining the precession of the substrate is that the data can be used to achieve a target precession rate. Since polishing uniformity of the substrate can depend on the precession rate, this permits a polishing parameter, e.g., a rotation rate of the platen 30 or carrier head 100, to be adjusted to provide a target precession rate. For example, if the controller 90 determines that the precession is higher than a target precession, the controller can decrease the difference between the carrier head rotation rate and the platen rotation rate in order to reduce the substrate precession rate. Conversely, if the controller 90 determines that the precession is lower than a target precession, the controller can increase the difference between the carrier head rotation rate and the platen rotation rate in order to increase the substrate precession rate.

A number of embodiments have been described. Nevertheless, it will be understood that various modifications may be made. For example, although the carrier head has been described as part of a chemical mechanical polishing apparatus, it may be adaptable to other types of processing systems, e.g., wafer transfer robots or electroplating systems. In the CMP system, the platen need not be rotatable or could be omitted entirely, and the pad could be circular or linear and could be suspended between rollers rather than attached to a platen.

Accordingly, other embodiments are within the scope of the following claims.

What is claimed is:

1. A carrier head for a chemical mechanical polishing system, comprising:
a base;
a flexible membrane connected to and extending beneath the base to define a pressurizable chamber therebetween, the flexible membrane having a lower surface to provide a substrate-mounting surface;
a thermocouple on the lower surface of the flexible membrane or embedded in the flexible membrane adjacent the lower surface; and
wiring to provide access to a signal from the thermocouple.

2. The carrier head of claim 1, comprising a plurality of thermocouples thermocouple on the lower surface of the flexible membrane or embedded in the flexible membrane adjacent the lower surface.

3. The carrier head of claim 2, wherein the plurality of thermocouples are positioned at different radial distances from a center of the substrate-mounting surface.

4. The carrier head of claim 3, wherein the plurality of thermocouples are positioned along a radial line extending from the center of the substrate-mounting surface.

5. The carrier head of claim 3, wherein adjacent pairs of thermocouples of the plurality of thermocouples are separated by equal radial distances.

6. The carrier head of claim 3, wherein a first thermocouple of the plurality of thermocouples is positioned at the center of the substrate mounting surface and a second thermocouple of the plurality of thermocouples is positioned adjacent an edge of the substrate mounting surface.

7. The carrier head of claim 1, wherein the thermocouple is positioned on the lower surface of the flexible membrane.

8. The carrier head of claim 1, wherein the thermocouple is embedded in the flexible membrane adjacent the lower surface.

9. The carrier head of claim 1, comprising a signal processor secured to the carrier head, and wherein the wiring connects the thermocouple to the signal processor, and wherein the signal processor is configured to generate digital temperature values from the signal from the thermocouple.

10. The carrier head of claim 9, comprising a data storage device configured to store the digital temperature values.

11. A chemical mechanical polishing system, comprising:
a carrier head including a substrate mounting surface and an optical sensor secured to the head and positioned to sense a reflectivity of a spot on a back surface of a substrate held in the carrier head; and
a controller configured to receive a signal from the optical sensor and determine precession of the substrate based on the signal.

12. The system of claim 11, wherein the optical sensor comprises a light source configured to direct a light beam to the spot on the back surface and a detector configured to sense reflections of the light beam from the back surface.

13. The system of claim 12, wherein the carrier head includes a base and a flexible membrane connected to and extending beneath the base to define a pressurizable chamber therebetween, the flexible membrane having a lower surface to provide the substrate-mounting surface.

14. The system of claim 13, wherein the light source is positioned to direct the light beam through the flexible membrane and receive reflections of the light beam through the flexible membrane.

15. The system of claim 14, wherein optical sensor is positioned in the chamber.

16. The system of claim 11, wherein the controller is configured to calculate a rate of precession of the substrate.

17. The system of claim 11, wherein the controller is configured to calculate an angular position of the substrate.

18. The system of claim 11, wherein the optical sensor generates an intensity signal and the controller is configured to detect a valley in the signal.

19. The system of claim 11, comprising the substrate, the substrate having a feature on the back surface with a different reflectivity than the remainder of the back surface.

20. The system of claim 19, wherein the feature comprises a marking of a material applied to the back surface of the substrate.

21. The system of claim 19, wherein the feature comprises a notch or flat of the substrate.
